(19) United States
(12) Patent Application Publication
(10) Pub. No.: US 2013/0342727 A1
(43) Pub. Date: Dec. 26, 2013

(54) ELECTRONIC CAMERA

(71) Applicant: Xacti Corporation, Daito-shi (JP)

(72) Inventor: Masayoshi Okamoto, Daito-shi (JP)

(21) Appl. No.: 13/926,579

(22) Filed: Jun. 25, 2013

(30) Foreign Application Priority Data
Jun. 25, 2012 (JP) 2012-141839

(51) Int. Cl. H04N 5/235

(52) U.S. Cl. CPC H04N 5/2353
USPC 348/229.1

(57) ABSTRACT

An electronic camera includes a first exposer. A first exposer exposes an imager in a plurality of exposure amounts different from each other when an exposure operation is accepted. An acquirer acquires a plurality of electronic images generated by a process of the first exposer, from the imager. A reproducer reproduces any one of the plurality of electronic images acquired by the acquirer. An acceptor accepts a designating operation of designating a part of the electronic image reproduced by the reproducer. A designator designates, out of the plurality of electronic images acquired by the acquirer, an electronic image in which a brightness of a partial image designated by the designating operation indicates an appropriate value, as a target of the reproducer.

### CROSS REFERENCE OF RELATED APPLICATION

The disclosure of Japanese Patent Application No. 2012-141839, which was filed on Jun. 25, 2012, is incorporated herein by reference.

### BACKGROUND OF THE INVENTION

1. Field of the Invention

The present invention relates to an electronic camera, and in particular, relates to an electronic camera which continuously takes a plurality of images.

2. Description of the Related Art

According to one example of this type of camera, an imager performs an imaging operation corresponding to a zoom ratio at each time point at which a zoom ratio variable lens practically reaches a state corresponding to each of a plurality of zoom ratios fixedly set in advance. A lens driver immediately drives the zoom ratio variable lens to a state corresponding to a succeeding zoom ratio, every time the imaging operation by the imager is ended.

However, in the above-described camera, there is a possibility that a zoom magnification and an angle of view desired by an operator at a time of reproducing do not coincide with a zoom magnification and an angle of view of an acquired image. Moreover, even if they are coincident with each other, there is a high possibility that an image quality of the acquired image is not an image quality desired by the operator, and therefore, an operability of reproduction may be deteriorated.

### SUMMARY OF THE INVENTION

An electronic camera according to the present invention comprises: a first exposer which exposes an imager in a plurality of exposure amounts different from each other when an exposure operation is accepted; an acquirer which acquires a plurality of electronic images generated by a process of the first exposer, from the imager; a reproducer which reproduces any one of the plurality of electronic images acquired by the acquirer; an acceptor which accepts a designating operation of designating a part of the electronic image reproduced by the reproducer; and a designator which designates, out of the plurality of electronic images acquired by the acquirer, an electronic image in which a brightness of a partial image designated by the designating operation indicates an appropriate value, as a target of the reproducer.

According to the present invention, an image processing program recorded on a non-transitory recording medium in order to control an electronic camera provided with an imager, the program causing a processor of the electronic camera to perform the steps comprises: a first exposing step of exposing an imager in a plurality of exposure amounts different from each other when an exposure operation is accepted; an acquiring step of acquiring a plurality of electronic images generated by a process of the first exposing step, from the imager; a reproducing step of reproducing any one of the plurality of electronic images acquired by the acquiring step; an accepting step of accepting a designating operation of designating a part of the electronic image reproduced by the reproducing step; and a designating step of designating, out of the plurality of electronic images acquired by the acquiring step, an electronic image in which a brightness of a partial image designated by the designating operation indicates an appropriate value, as a target of the reproducer.

According to the present invention, An image processing method executed by an electronic camera provided with an imager, comprises: a first exposing step of exposing an imager in a plurality of exposure amounts different from each other when an exposure operation is accepted; an acquiring step of acquiring a plurality of electronic images generated by a process of the first exposing step, from the imager; a reproducing step of reproducing any one of the plurality of electronic images acquired by the acquiring step; an accepting step of accepting a designating operation of designating a part of the electronic image reproduced by the reproducing step; and a designating step of designating, out of the plurality of electronic images acquired by the acquiring step, an electronic image in which a brightness of a partial image designated by the designating operation indicates an appropriate value, as a target of the reproducer.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an assignment state of an evaluation area in an imaging surface;

FIG. 4 is an illustrative view showing one example of a scene captured by the imaging surface;

FIG. 5 is an illustrative view showing one example of a plurality of taken images;

FIG. 6 is an illustrative view showing one example of a configuration of a table referred to in the embodiment in FIG. 2;

FIG. 7 is an illustrative view showing one example of a configuration of a register referred to in the embodiment in FIG. 2;

FIG. 8 (A) is one example of a tag added to an image file;

FIG. 8 (B) is an illustrative view showing one example of a detail of a part of the tag shown in FIG. 8 (A);

FIG. 9 (A) is an illustrative view showing one example of a zoom-in operation;

FIG. 9 (B) is an illustrative view showing another example of the zoom-in operation;

FIG. 10 is an illustrative view showing one example of a zoom-in frame structure;

FIG. 11 is an illustrative view showing one example of a zoom-in process;

FIG. 12 is an illustrative view showing another example of the zoom-in frame structure;

FIG. 13 is an illustrative view showing another example of the zoom-in process;

FIG. 14 is an illustrative view showing one example of a zoom-out frame structure;

FIG. 15 is a flowchart showing one portion of behavior of a CPU applied to the embodiment in FIG. 2;

FIG. 16 is a flowchart showing another portion of behavior of the CPU applied to the embodiment in FIG. 2;

FIG. 17 is a flowchart showing still another portion of behavior of the CPU applied to the embodiment in FIG. 2;

FIG. 18 is a flowchart showing yet another portion of behavior of the CPU applied to the embodiment in FIG. 2;

FIG. 19 is a flowchart showing another portion of behavior of the CPU applied to the embodiment in FIG. 2;

FIG. 20 is a flowchart showing still another portion of behavior of the CPU applied to the embodiment in FIG. 2; and

FIG. 21 is a block diagram showing a configuration of another embodiment of the present invention.

### DETAILED DESCRIPTION OF THE PREFERRED EMBODIMENTS

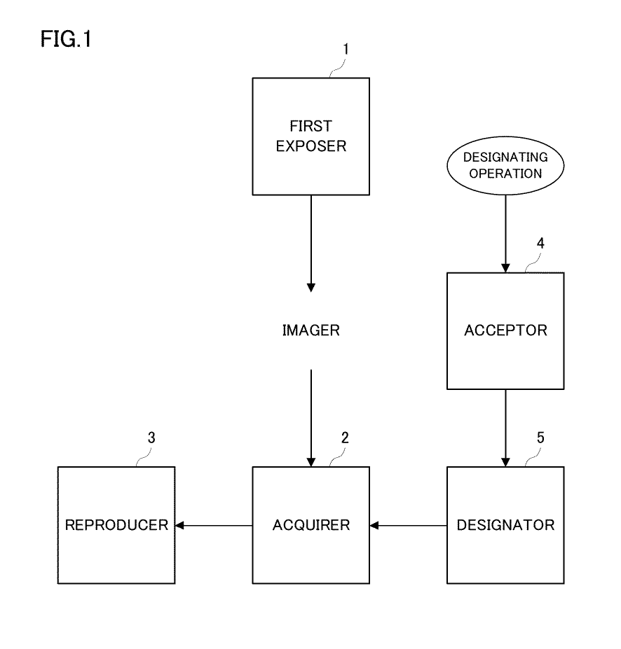

With reference to FIG. 1, an electronic camera according to one embodiment of the present invention is basically configured as follows: A first exposer 1 exposes an imager in a plurality of exposure amounts different from each other when an exposure operation is accepted. An acquirer 2 acquires a plurality of electronic images generated by a process of the first exposer 1, from the imager. A reproducer 3 reproduces any one of the plurality of electronic images acquired by the acquirer 2. An acceptor 4 accepts a designating operation of designating a part of the electronic image reproduced by the reproducer 3. A designator 5 designates, out of the plurality of electronic images acquired by the acquirer 2, an electronic image in which a brightness of a partial image designated by the designating operation indicates an appropriate value, as a target of the reproducer 3.

The plurality of electronic images acquired in response to the exposure operation have brightness different from each other, and any one of the acquired plurality of electronic images is reproduced. When a part of the reproduced electronic image is designated by the designating operation, the electronic image in which the brightness of the designated partial image indicates the appropriate value is alternately reproduced. Thereby, an operability of reproduction is improved.

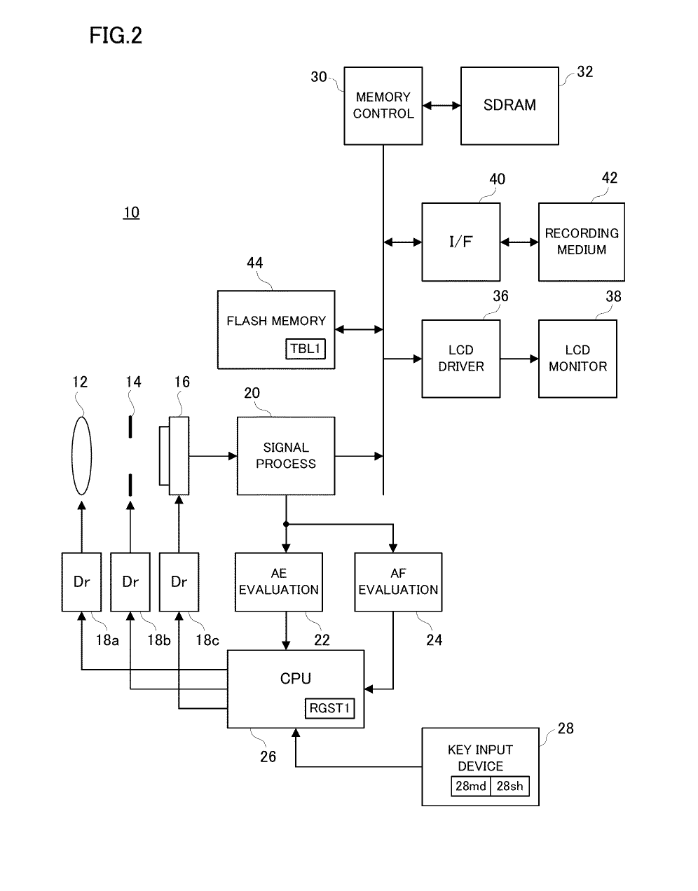

With reference to FIG. 2, a digital camera 10 according to one embodiment includes a focus lens 12 and an aperture unit 14 driven by drivers 18a and 18b, respectively. An optical image that underwent these components enters, with irradiation, an imaging surface of an image sensor 16, and is subjected to a photoelectric conversion. Thereby, electric charges representing a scene are produced.

When a power source is applied, under a main task, a CPU 26 determines a state of a mode changing button 28md arranged in a key input device 28 (i.e., an operation mode at a current time point). The CPU 26 activates an imaging task when a normal photographing mode or an exposure bracket photographing mode is selected by the mode setting switch 28md arranged in a key input device 28, and activates a reproducing task when a reproducing mode is selected by the same mode setting switch 28md.

When the imaging task is activated, in order to execute a moving image taking process, the CPU 26 commands a driver 18c to repeat an exposure procedure and an electric-charge reading-out procedure. In response to a vertical synchronization signal Vsync periodically generated from an SG (Signal Generator) not shown, the driver 18c exposes the imaging surface and reads out the electric charges produced on the imaging surface in a raster scanning manner. From the image sensor 16, raw image data that is based on the read-out electric charges is cyclically outputted.

A signal processing circuit 20 performs processes, such as digital clamp, pixel defect correction, gain control and etc., on the raw image data outputted from the imager 16. The raw image data on which these processes are performed is written into an SDRAM 32 through a memory control circuit 30. Furthermore, the signal processing circuit 20 reads out the raw image data stored in the SDRAM 32 through the memory control circuit 30, performs a color separation process, a white balance adjusting process and a YUV converting process, on the read-out raw image data, and creates display image data that comply with the YUV format. The display image data is written into the SDRAM 32 by the memory control circuit 30.

An LCD driver 36 repeatedly reads out the display image data stored in the SDRAM 32 through the memory control circuit 30, and drives an LCD monitor 38 based on the read-out image data. As a result, a real-time moving image (a live view image) representing the scene is displayed on the LCD monitor 38.

Moreover, the CPU 26 places the focus lens 12 at a pan focus position which is an initial setting position through the driver 18a.

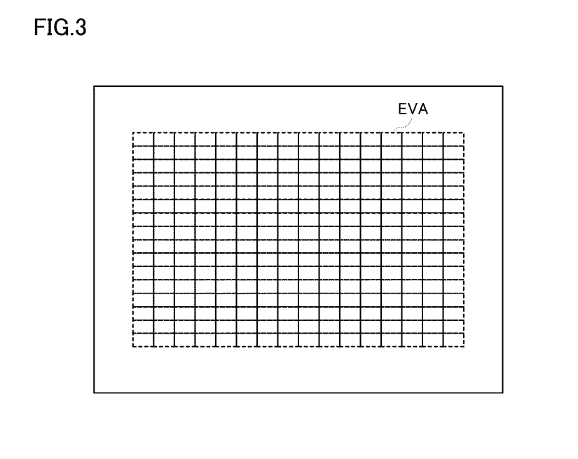

With reference to FIG. 3, an evaluation area EVA is assigned to a center of the imaging surface. The evaluation area EVA is divided into 16 portions in each of a horizontal direction and a vertical direction; therefore, the evaluation area EVA is formed of 256 divided areas. Moreover, in addition to the above-described processes, the signal processing circuit 20 executes a simple RGB converting process which simply converts the raw image data into RGB data.

An AE evaluating circuit 22 integrates RGB data belonging to the evaluation area EVA, out of the RGB data produced by the signal processing circuit 20, at every time the vertical synchronization signal Vsync is generated. Thereby, 256 integral values (256 AE evaluation values) are outputted from the AE evaluating circuit 22 in response to the vertical synchronization signal Vsync. An AF evaluating circuit 24 integrates a high-frequency component of the RGB data belonging to the evaluation area EVA, out of the RGB data generated by the signal processing circuit 20, at every time the vertical synchronization signal Vsync is generated. Thereby, 256 integral values (256 AF evaluation values) are outputted from the AF evaluating circuit 24 in response to the vertical synchronization signal Vsync.

When a shutter button 28sh is in a non-operated state, the CPU 26 executes a simple AE process that is based on output from the AE evaluating circuit 22 so as to calculate an appropriate EV value. The simple AE process is executed in parallel with the moving-image taking process, and an aperture amount and an exposure time period that define the calculated EV value are set to the drivers 18b and 18c, respectively. As a result, a brightness of the live view image is adjusted approximately.

When the shutter button 28sh is half-depressed, the CPU 26 executes a strict AE process based on the output from the AE evaluating circuit 22. An aperture amount and an exposure time period that define an EV value calculated by the strict AE process are set to the drivers 18b and 18c, respectively. As a result, the brightness of the live view image is adjusted strictly.

Upon completion of the strict AE process, the CPU 26 executes a strict AF process that is based on output from the AF evaluating circuit 24. As a result, the focus lens 12 is placed at a focal point, and thereby, a sharpness of the live view image is improved.

When the shutter button 28sh is fully depressed, if the normal photographing mode is selected by the mode setting switch 28md, the CPU 26 executes a still-image taking process and a recording process under the imaging task. One frame of image data at a time point at which the shutter button 28sh is fully depressed is taken into the SDRAM 32 by the still-image taking process. The taken one frame of the image data is read out from the SDRAM 32 by an I/F 40 activated in association with the recording process, and is recorded on the recording medium 42 in a file format.

On the other hand, when the shutter button 28sh is fully depressed, if the exposure bracket photographing mode is selected by the mode setting switch 28md, the CPU 26 executes processes for an exposure bracket photographing in a manner described below.

The exposure bracket photographing is a photographing manner of acquiring a plurality of image data mutually different in brightness by executing the still-image taking process continuously while changing the exposure setting gradually.

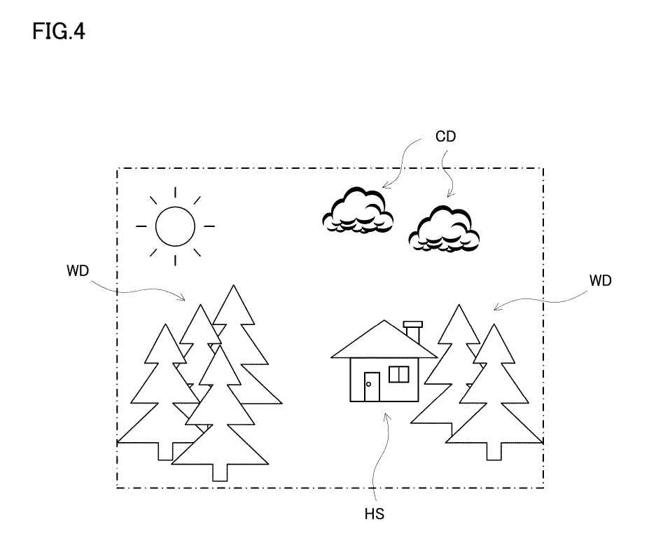

For example, when the still-image taking process is performed eleven times while the exposure setting is changed for a scene of an example shown in FIG. 4, eleven frame images FR1 to FR11 shown in FIG. 5 are acquired. According to an example shown in FIG. 5, the frame image FR6 is acquired based on an exposure setting indicated by the EV value calculated by the strict AE process. Moreover, the frame images FR7 to FR11 indicate images acquired based on an exposure setting in which an EV value of the frame image FR6 is gradually increased and changed, and the frame images FR5 to FR1 indicate images acquired based on an exposure setting in which the EV value of the frame image FR6 is gradually decreased and changed.

With reference to FIG. 4 and FIG. 5, an EV value is calculated by the strict AE process in which a center of an image is emphasized, and therefore, a brightness of an area around the center of the image becomes appropriate. As a result, in the frame image FR6, a brightness of a house HS near the center of the image becomes appropriate.

In the frame image FR11 acquired by changing the exposure setting to a plus side maximum, the house HS of which brightness is appropriate in the frame image FR6 is in a state of being overexposed. However, a brightness of trees WD that are in a state of being underexposed in the frame image FR6 is appropriate in the frame image FR11.

In the frame image FR1 acquired by changing the exposure setting to a minus side minimum, the house HS of which brightness is appropriate in the frame image FR6 is in a state of being underexposed. However, a brightness of clouds CD that are in the state of being overexposed in the frame image FR6 is appropriate in the frame image FR1.

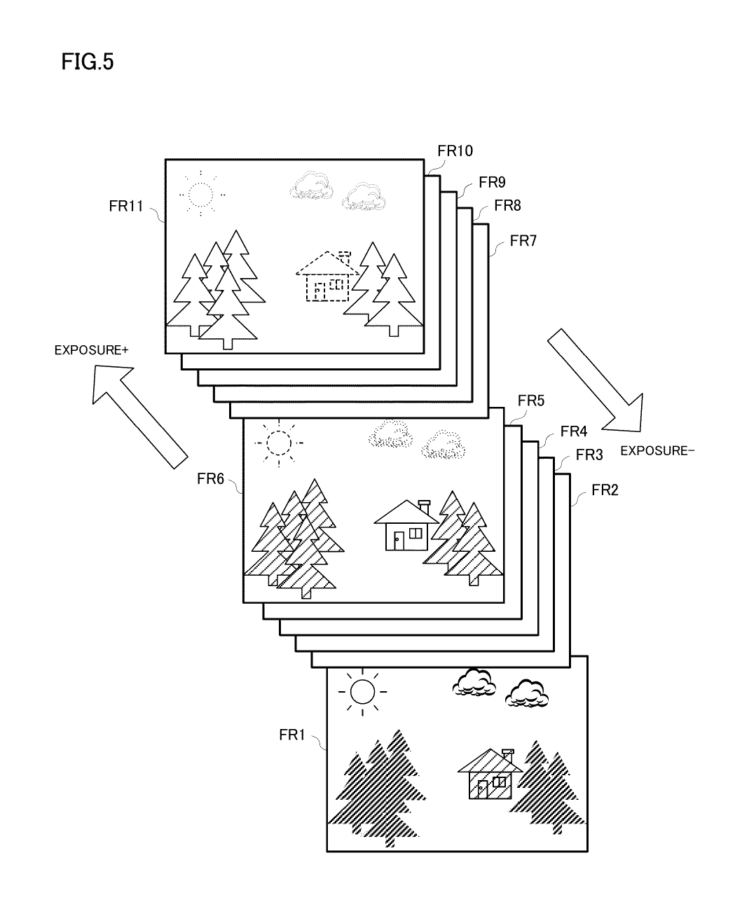

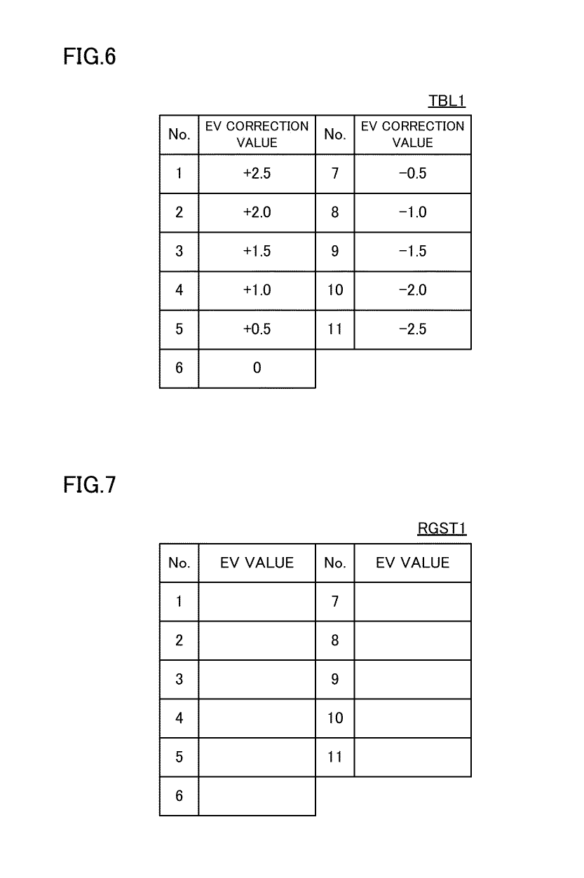

For the exposure bracket photographing, a table TBL1 shown in FIG. 6 is prepared. In the table TBL1, EV correction values indicating a magnitude of correcting the EV value calculated by the strict AE process are contained as many times as the exposure bracket photographing is executed. It is noted that that the table TBL1 is stored in a flash memory 44.

Firstly, the CPU 26 calculates a plurality of EV values each of which indicates an exposure setting for each photographing, based on the EV value calculated by the strict AE process and a plurality of EV correction values contained in the table TBL1. The calculated plurality of EV values are registered in a register RGST1 shown in FIG. 7.

Subsequently, the CPU 26 creates an exposure bracket image file for storing a plurality of image data acquired by the exposure bracket photographing, in a recording medium 42. Moreover, the CPU 26 creates a tag described in a header of the exposure bracket image file.

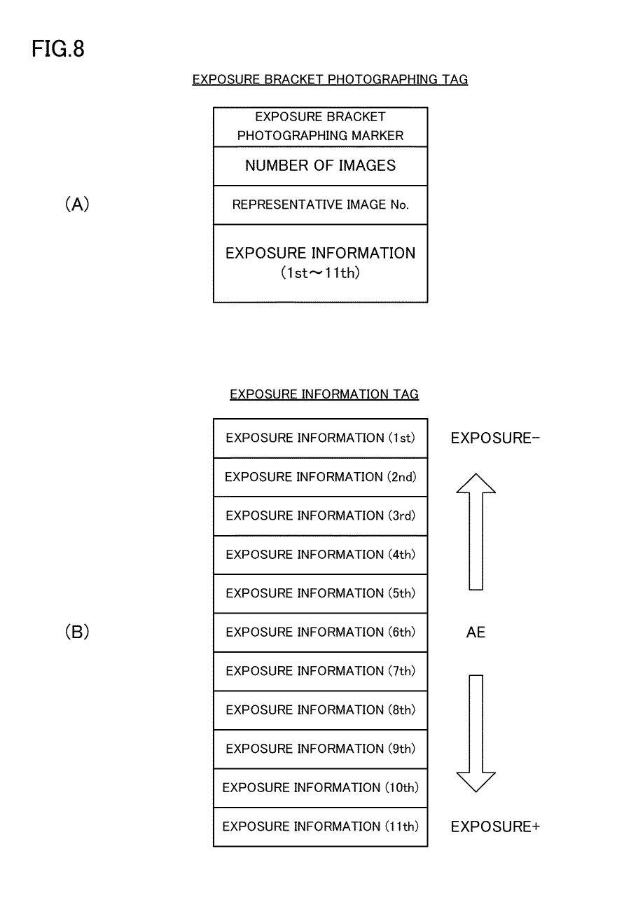

With reference to FIG. 8 (A), in the exposure bracket image file, besides a tag of an image file for normal photographing, created are four tags “exposure bracket photographing marker”, “number of images”, “representative image number” and “exposure information”.

The “exposure bracket photographing marker” is a tag for describing that it is the exposure bracket image file, and the “number of images” is a tag for describing the number of images to be stored in the file. The “representative image number” is a tag for describing a number of an image to be a representative out of a plurality of images stored in the file, and the “exposure information” is a tag for describing an exposure setting at a time of acquiring each image stored in the file.

For example, when eleven images are stored in the exposure bracket image file, “11” is described in the tag “number of images”. Moreover, in the example shown in FIG. 5, when a number identifying the frame image indicates an order of acquisition, the frame image FR6 acquired based on the exposure setting by the strict AE process is used as a representative image, and “6” is described in the tag “representative image number”.

With reference to FIG. 8 (B), the tags “exposure information” are created as many as the number of images stored in the file. In each of the tags “exposure information”, the EV value registered in the register RGST1 may be described, or the aperture amount and the exposure time period that define the calculated EV value may be described.

The CPU 26 sequentially reads out the plurality of EV values registered in the register RGST1 so as to execute the still-image taking process and a file recording process on each EV value in a manner described below. An aperture amount and an exposure time period that define any of the EV values read out from the register RGST1 are respectively set to the drivers 18b and 18c. The CPU 26 waits until the vertical synchronization signal Vsync is generated for the first time after completion of the setting, and thereafter, executes the still-image taking process. As a result, one frame of image data immediately after changes of the aperture amount and the exposure time period are reflected is taken into the SDRAM 32 by the still-image taking process. The taken one frame of the image data is read out from the SDRAM 32 by the I/F 40, and is recorded on the exposure bracket image file created in the recording medium 42.

Thus, upon completion of the exposure bracket photographing, the CPU 26 returns to the state where the shutter button 28sh is non-operated so as to repeatedly execute the simple AE process.

When the reproducing task is activated, the CPU 26 designates the latest image file recorded in the recording medium 42 under the reproducing task, and reads out a tag of the designated image file. Based on the description of the exposure bracket photographing marker out of the read-out tag information, the CPU 26 determines whether or not the designated image file is the exposure bracket image file created as described above.

When the designated image file is an image file created by the normal photographing, the CPU 26 reproduces image data stored in the designated image file on the LCD monitor 38. When the designated image file is the exposure bracket image file, based on the description of the representative image number out of the read-out tag information, the CPU 26 selects representative image data from among a plurality of image data stored in the file so as to reproduce on the LCD monitor 38.

On the other hand, the operator is able to perform a zoom operation for enlargement and reduction during execution of the reproducing task through the key input device 28.

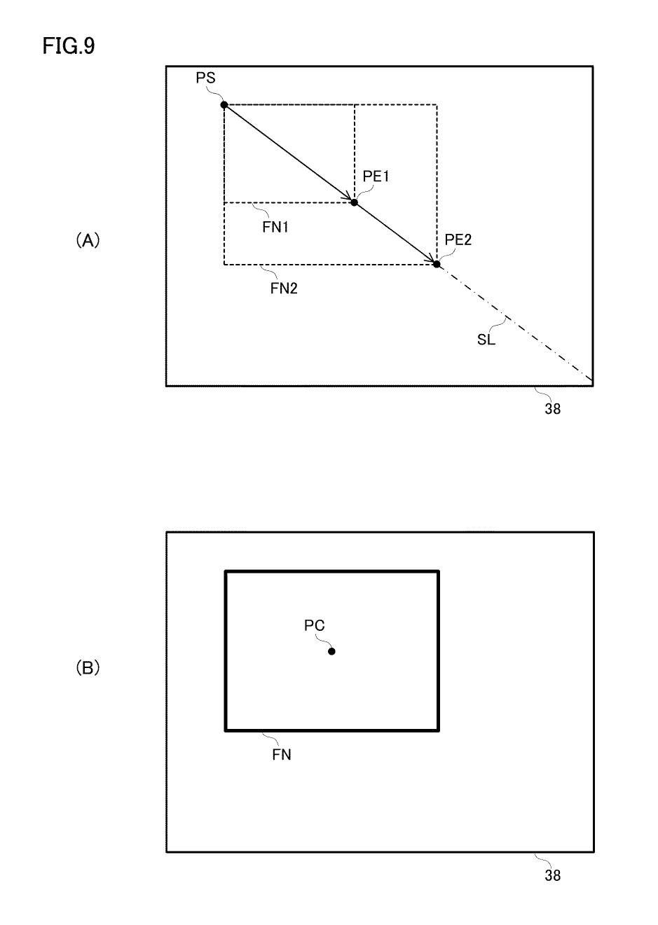

For example, with reference to FIG. 9 (A), a zoom-in operation is performed by the operator designating a lower right position PE after designating an upper left position PS of a zoom-in frame structure FN through the key input device 28. The operator is able to freely select the upper left position PS in the image, whereas is able to freely select the lower right position PE on a straight line SL for maintaining an aspect ratio of the image. In this case, when a lower right position PE1 is designated, a zoom-in frame structure FN1 is defined, and when a lower right position PE2 is designated, a zoom-in frame structure FN2 is defined.

Moreover, with reference to FIG. 9 (B), the zoom-in operation may be performed by designating a center position PC of the zoom-in frame structure FN. In this case, a size of the zoom-in frame structure FN may be fixed: for example, the zoom-in frame structure FN is set to 0.5 times the length of the whole image, regarding each of vertical and horizontal lengths. Moreover, the center position PC may be designated within a predetermined range so that the zoom-in frame structure FN is contained within the image, or a position of the zoom-in frame structure FN may be adjusted after the center position PC is freely designated within the image.

When the zoom-in operation is performed by the operator, the CPU 26 executes a process of zooming to display in a manner described below.

The CPU 26 calculates an appropriate EV value of a range indicated by the zoom-in frame structure FN. Subsequently, based on the description of the exposure information out of the read-out tag information, the CPU 26 selects image data photographed at an EV value proximate to the calculated EV value, from among the plurality of image data stored in the exposure bracket image file that is being reproduced.

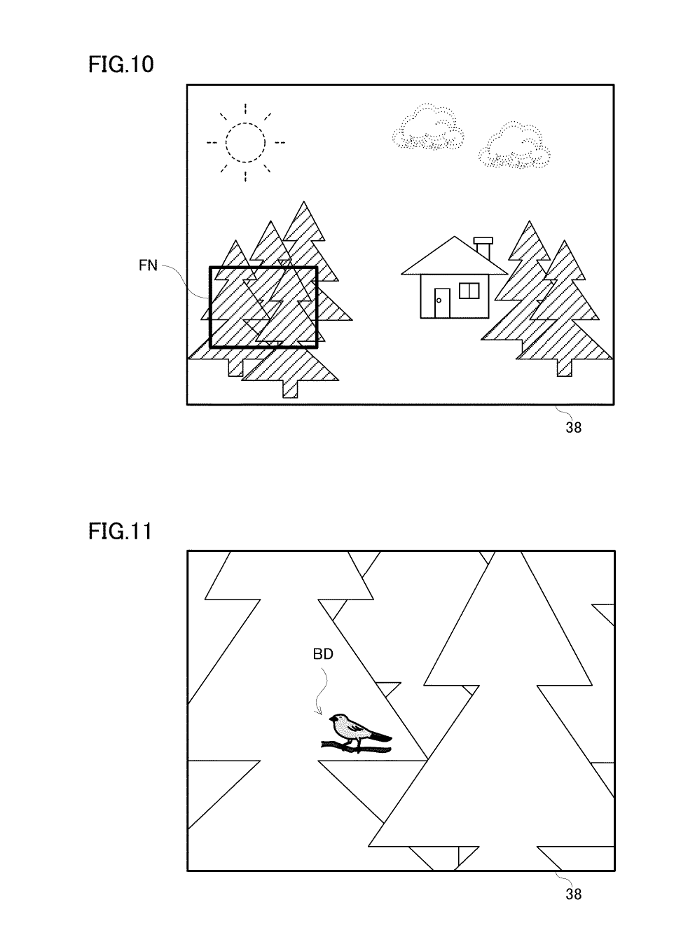

With reference to FIG. 10, a range indicated by the zoom-in frame structure FN in the frame image FR6 (FIG. 5) that is being reproduced is almost occupied by the trees WD, and is in the state of being underexposed resulting from backlight. On the other hand, in the frame image FR11 shown in FIG. 5, a brightness of the trees WD is appropriate. Therefore, in this case, the frame image FR11 is selected.

Subsequently, the CPU 26 enlarges and displays the range indicated by the zoom-in frame structure FN out of the selected image at a magnification coincident with a display region of the LCD monitor 38. Thus, according to an example shown in FIG. 10, an image shown in FIG. 11 is displayed on the LCD monitor 38 by the zoom display. Moreover, as a result of enlarging and displaying with an appropriate brightness, it becomes possible for the operator to recognize by sight a bird BD which was invisible until the zoom operation.

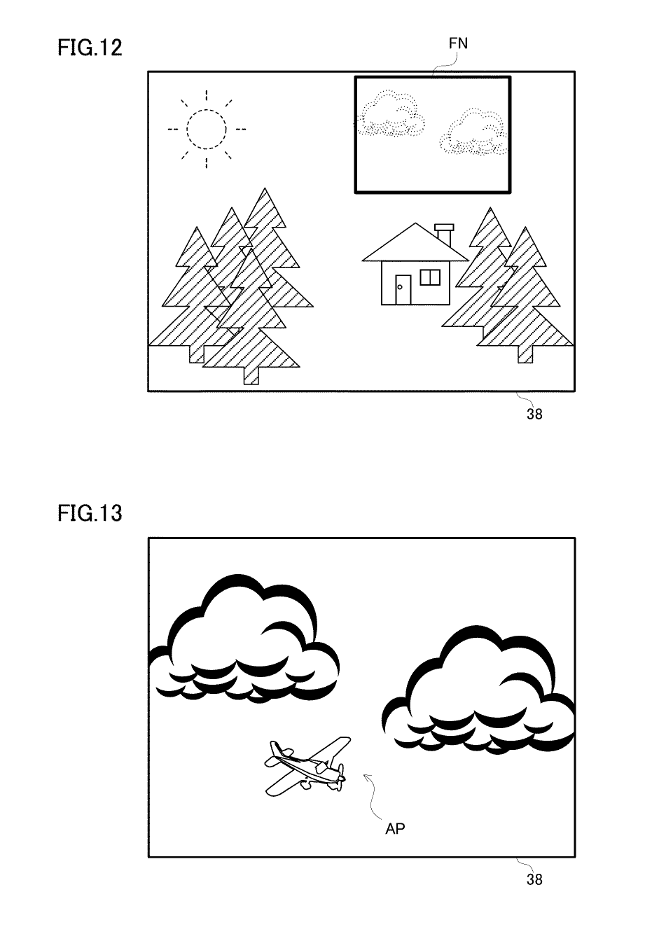

With reference to FIG. 12, a range indicated by the zoom-in frame structure FN in the frame image FR6 (FIG. 5) that is being reproduced is almost occupied by the clouds CD, and is in the state of being overexposed resulting from sunlight. On the other hand, in the frame image FR1 shown in FIG. 5, a brightness of the clouds CD is appropriate. Therefore, in this case, the frame image FR1 is selected. In this case, an image shown in FIG. 13 is displayed on the LCD monitor 38 by the zoom display. Moreover, as a result of enlarging and displaying with the appropriate brightness, it becomes possible for the operator to recognize by sight an airplane AP which was invisible until the zoom operation, on the LCD monitor 38.

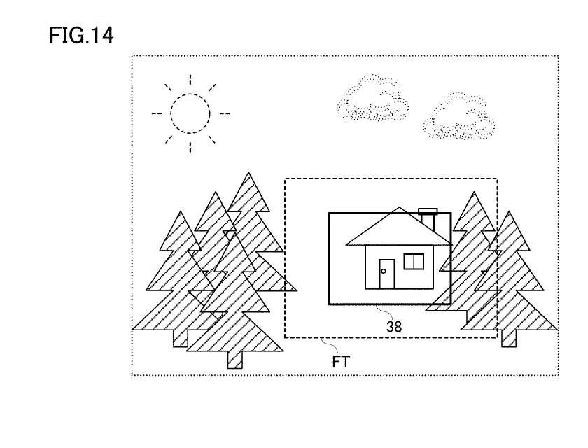

With reference to FIG. 14, a process of zooming to display by a zoom-out operation after the zoom-in display may be performed by defining a zoom-out frame structure FT of a predetermined size, centering around a range that is being displayed. In this case, a position of the zoom-out frame structure FT may be adjusted so as to be contained within a range of an image: for example, a size of the zoom-out frame structure FT is set to 0.5 times the length of the whole image, regarding each of vertical and horizontal lengths. Thus, after the zoom-out frame structure FT is defined, similarly as a case of the zoom-in operation described above, the CPU 26 calculates an appropriate EV value of a range indicated by the zoom-out frame structure FT, and selects image data based on the calculated EV value. The range indicated by the zoom-out frame structure FT out of the image of the selected image data is enlarged and displayed at a magnification coincident with a display region of the LCD monitor 38.

It is noted that, when the zoom-out operation is performed while a range greater than 0.5 times the length of the whole image regarding each of vertical and horizontal lengths is subjected to the zoom-in display, the process may be returned to reproduce the representative image data.

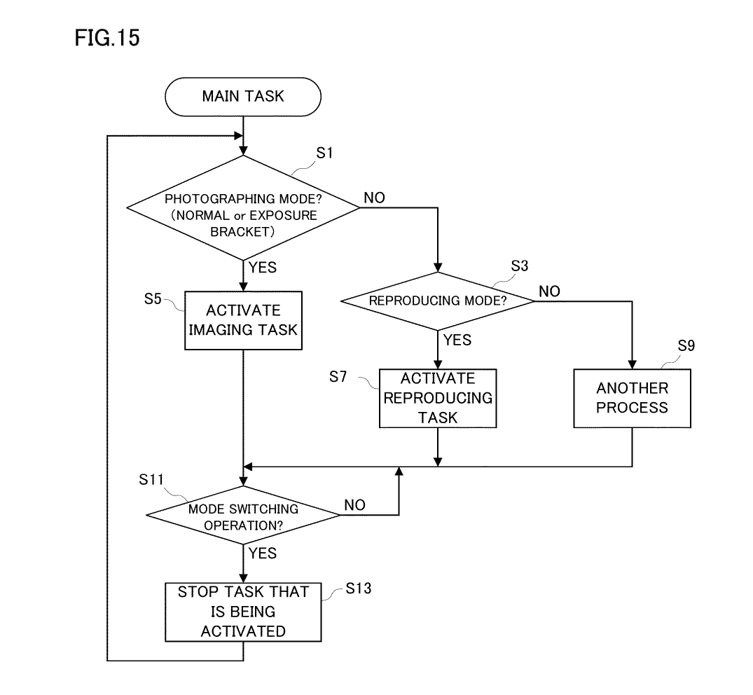

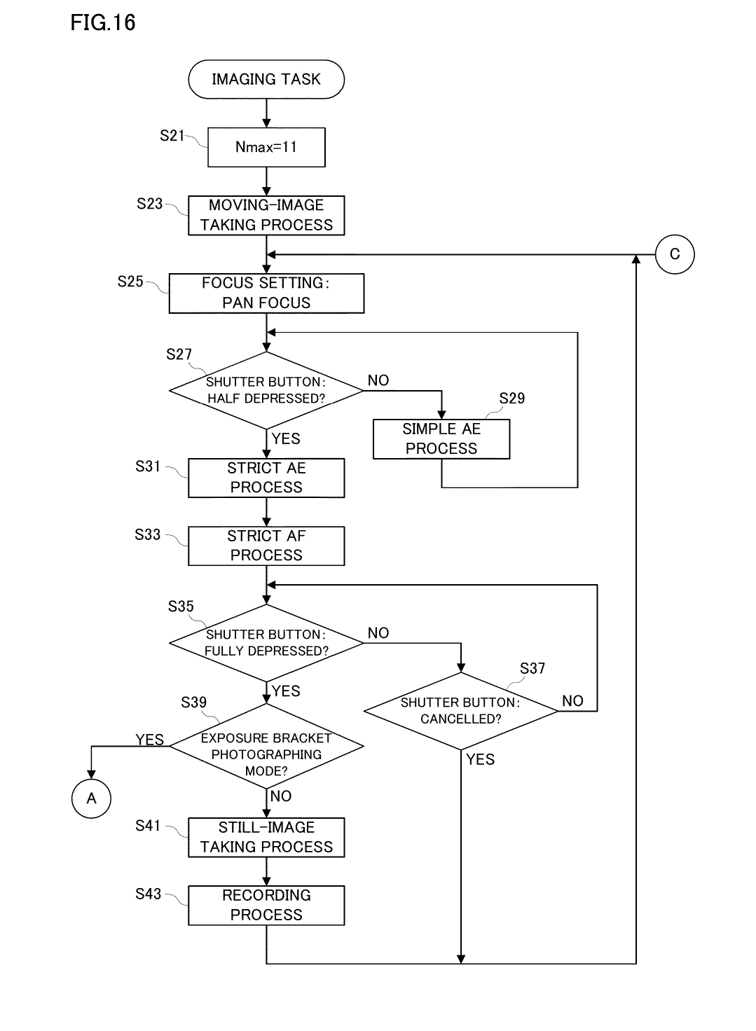

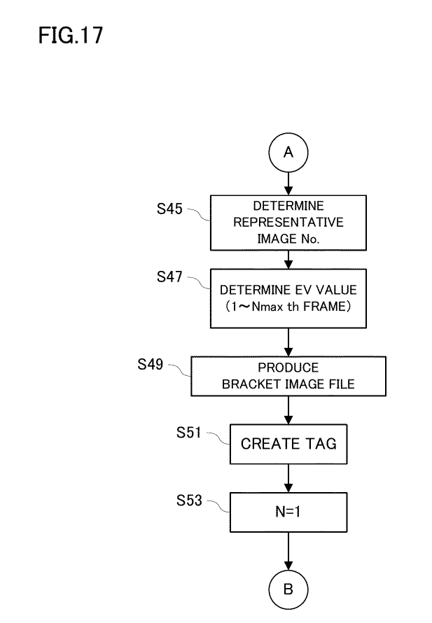

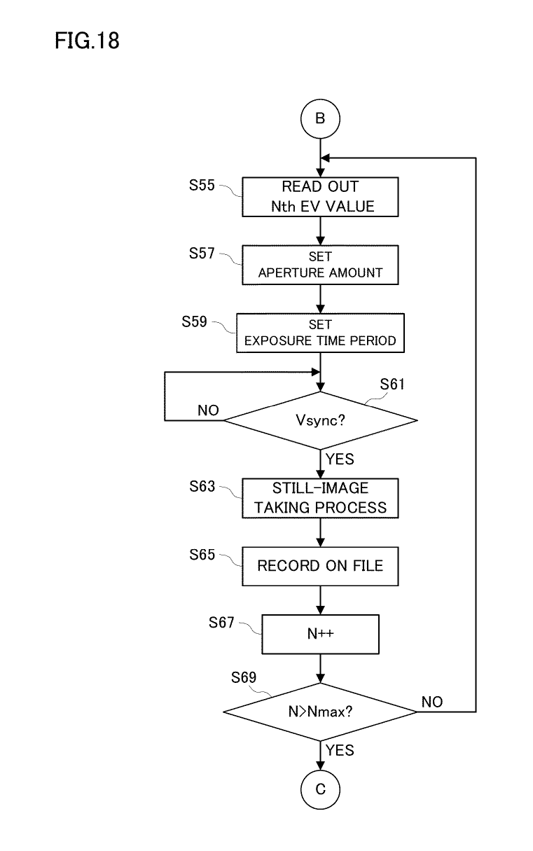

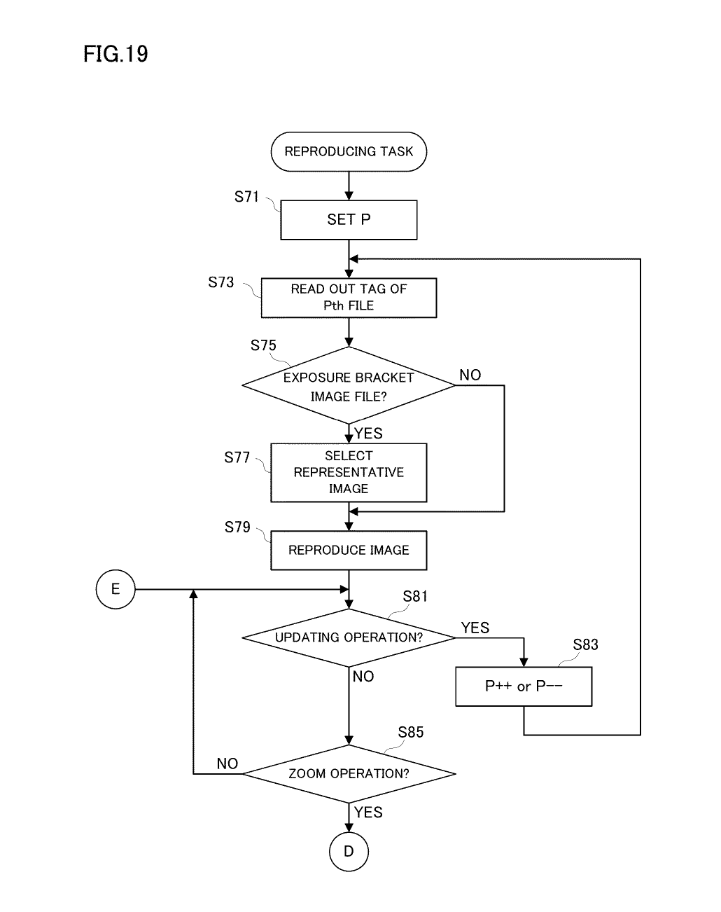

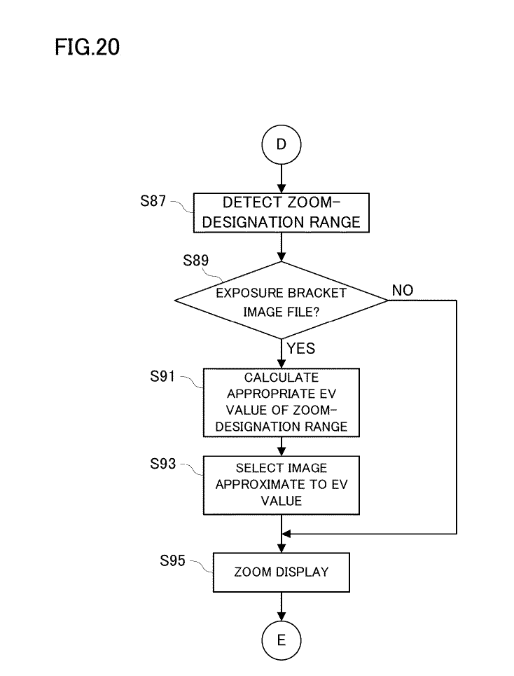

The CPU 26 executes a plurality of tasks including the main task shown in FIG. 15, and imaging task shown in FIG. 16 to FIG. 18 and the reproducing task shown in FIG. 19 to FIG. 20, in a parallel manner. It is noted that, control programs corresponding to these tasks are stored in the flash memory 44.

With reference to FIG. 15, in a step S1, it is determined whether or not an operation mode at a current time point is the normal photographing mode or the exposure bracket photographing mode, and in a step S3, it is determined whether or not an operation mode at a current time point is the reproducing mode. When YES is determined in the step S1, the imaging task is activated in a step S5, and when YES is determined in the step S3, the reproducing task is activated in a step S7. When NO is determined in both of the steps S1 and S3, another process is executed in a step S9. Upon completion of any of the processes in the steps S5 to S9, it is repeatedly determined in a step S11 whether or not a mode switching operation is performed. When a determined result is updated from NO to YES, the task that is being activated is stopped in a step S13, and thereafter, the process returns to the step S1.

With reference to FIG. 16, in a step S21, a maximum value Nmax of a variable N is set to “11”, and in a step S23, the moving image taking process is started. As a result, a live view image is displayed on the LCD monitor 38. In a step S25, the focus lens 12 is placed at the pan focus position which is the initial setting position through the driver 18a.

In a step S27, it is determined whether or not the shutter button 28sh is half depressed, and in a step S29, the simple AE process is executed while a determined result is NO. As a result, a brightness of the live view image is adjusted approximately.

When the determined result is updated from NO to YES, in a step S31, the strict AE process is executed. As a result, the brightness of the live view image is adjusted strictly. In a step S33, the strict AF process is executed. As a result, the focus lens 12 is placed at a focal point, and thereby, a sharpness of the live view image is improved.

In a step S35, it is determined whether or not the shutter button 28sh is fully depressed, and when a determined result is NO, in a step S37, it is determined whether or not a half-depressed state of the shutter button 28sh is cancelled. When a determined result of the step S37 is NO, the process returns to the step S35 whereas when the determined result of the step S37 is YES, the process returns to the step S25.

When the determined result of the step S35 is YES, in a step S39, it is determined whether or not an operation mode at a current time point is the exposure bracket photographing mode. When a determined result of the step S39 is NO, the still-image taking process and the recording process are respectively executed in steps S41 and S43. One frame of image data at a time point at which the shutter button 28sh is fully depressed is taken into the SDRAM 32 by the still-image taking process. The taken one frame of the image data is read out from the SDRAM 32 by the I/F 40 activated in association with the recording process, and is recorded on the recording medium 42 in a file format. Upon completion of the process in the step S43, the process returns to the step S25.

When the determined result of the step S39 is YES, the representative image number of the exposure bracket image file is determined in a step S45. For example, the representative image number is defined as the number of the frame image acquired based on the exposure setting by the strict AE process.

In a step S47, based on the EV value calculated by the strict AE process and a plurality of EV correction values contained in the table TBL1, determined is an EV value to be set at each time of taking a still-image by the exposure bracket photographing. The determined plurality of EV values are registered in the register RGST1 is read out. In a step S49, an exposure bracket image file is created in the recording medium 42.

In a step S51, a tag described in a header of the exposure bracket image file is created. In the exposure bracket image file, besides a tag of an image file for normal photographing, created are four tags “exposure bracket photographing marker”, “number of images”, “representative image number” and “exposure information”.

In a step S53, the variable N is set to “1”, and in a step S55, the N-th EV value registered in the register RGST1 is read out. The aperture amount and the exposure time period that define the read-out EV value are respectively set to the drivers 18b and 18c in steps S57 and S59.

In a step S61, it is repeatedly determined whether or not the vertical synchronization signal Vsync is generated, and when a determined result is updated from NO to YES, in a step S63, the still-image taking process is executed. As a result, one frame of image data immediately after changes of the aperture amount (the step S57) and an exposure time period (the step S59) are reflected is taken into the SDRAM 32 by the still-image taking process.

In a step S65, the image data taken in the step S63 is recorded on the exposure bracket image file created in the step S49.

In a step S67, the variable N is incremented, and in a step S69, it is determined whether or not the variable N exceeds Nmax. When a determined result is NO, the process returns to the step S55 whereas when the determined result is YES, the process returns to the step S25.

With reference to FIG. 19, in a step S71, a variable P is set to a number indicating the latest image file, and in a step S73, a tag of the P-th image file recorded in the recording medium 42 is read out. In a step S75, based on a description of the exposure bracket photographing marker out of the read-out tag information, it is determined whether or not the P-th image file is the exposure bracket image file. When a determined result is NO, the process advances to a step S79 whereas when the determined result is YES, the process advances to the step S79 via a process in a step S77.

In the step S77, based on a description of the representative image number out of the tag information read out in the step S73, representative image data is selected from among a plurality of image data stored in the exposure bracket file. In the step S79, the representative image data selected in the step S77 or the image data stored in the normal image file is reproduced on the LCD monitor 38.

In a step S81, it is determined whether or not the operation of updating the reproduced file is performed by the operator, and when a determined result is YES, the variable P is incremented or decremented in a step S83, and thereafter, the process returns to the step S73. When the determined result is NO, the process advances to a step S85.

In the step S85, it is determined whether or not the zoom operation is performed through the key input device 28. When a determined result is NO, the process returns to the step S81 whereas when the determined result is YES, in a step S87, a range designated by the zoom operation is detected.

In a step S89, based on the description of the exposure bracket photographing marker out of the tag information read out in the step S73, it is determined whether or not an image file that is being reproduced is the exposure bracket image file. When a determined result is NO, the process advances to a step S95 whereas when the determined result is YES, the process advances to the step S95 via processes in steps S91 and S93.

In the step S91, calculated is an appropriate EV value of the range detected in the step S87. In the step S93, based on the description of the exposure information out of the tag information read out in the step S73, selected is image data photographed at an EV value proximate to the calculated EV value, from among the plurality of image data stored in the exposure bracket image file that is being reproduced.

In the step S95, the range detected in the step S87 out of an image of the image data selected in the step S93 or the image data stored in the normal image file is enlarged and displayed at a magnification coincident with a display region of the LCD monitor 38. Upon completion of the process in the step S95, the process returns to the step S81.

As can be seen from the above-described explanation, the CPU 26 exposes the image sensor 16 in the plurality of exposure amounts different from each other when the exposure operation is accepted, and acquires the generated plurality of electronic images, from the image sensor 16. Moreover, the CPU 26 reproduces any one of the acquired plurality of electronic images. The CPU 26 accepts the zoom operation of designating a part of the reproduced electronic image, and designates, out of the acquired plurality of electronic images, the electronic image in which the brightness of the partial image designated by the zoom operation indicates the appropriate value, as the target of the reproducing process.

The plurality of electronic images acquired in response to the exposure operation have brightness different from each other, and any one of the acquired plurality of electronic images is reproduced. When a part of the reproduced electronic image is designated by the zoom operation, the electronic image in which the brightness of the designated partial image indicates the appropriate value is alternately reproduced. Thereby, an operability of reproduction is improved.

It is noted that, in this embodiment, eleven image data are stored in the exposure bracket image file, however, a plurality of image data other than eleven image data may be stored.

Moreover, in this embodiment, by using the EV value calculated by the strict AE process as a reference, EV correction values of the same number are contained in the table TBL1, in a correction amount equal to each of the plus side and the minus side. However, the correction amount may be changed in each of the plus side and the minus side, or a ratio between the EV correction values of the plus side and the minus side may be changed.

Moreover, in this embodiment, the present invention is explained by using a digital still camera, however, a digital video camera, a tablet computer, cell phone units or a smartphone may be applied to.

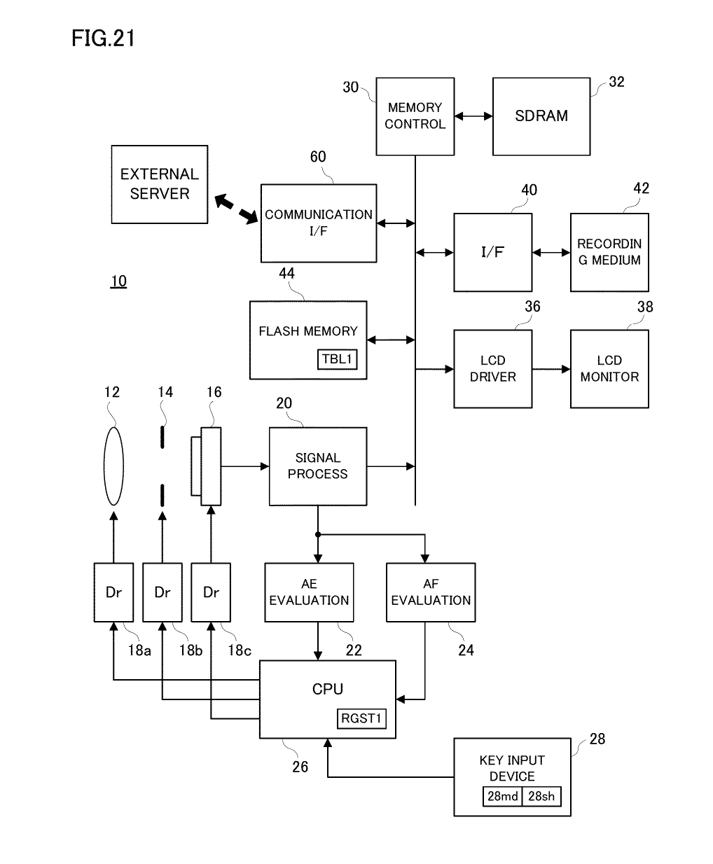

It is noted that, in this embodiment, the control programs equivalent to the multi task operating system and a plurality of tasks executed thereby are previously stored in the flash memory 44. However, a communication I/F 60 may be arranged in the digital camera 10 as shown in FIG. 21 so as to initially prepare a part of the control programs in the flash memory 44 as an internal control program whereas acquire another part of the control programs from an external server as an external control program. In this case, the above-described procedures are realized in cooperation with the internal control program and the external control program.

Moreover, in this embodiment, the processes executed by the CPU 26 are divided into a plurality of tasks including the main task shown in FIG. 15, the imaging task shown in FIG. 16 to FIG. 18 and the reproducing task shown in FIG. 19 to FIG. 20. However, these tasks may be further divided into a plurality of small tasks, and furthermore, a part of the divided plurality of small tasks may be integrated into another task. Moreover, when a transferring task is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
a first exposer which exposes an imager in a plurality of exposure amounts different from each other when an exposure operation is accepted;
an acquirer which acquires a plurality of electronic images generated by a process of said first exposer, from said imager;
a reproducer which reproduces any one of the plurality of electronic images acquired by said acquirer;
an acceptor which accepts a designating operation of designating a part of the electronic image reproduced by said reproducer; and
a designator which designates, out of the plurality of electronic images acquired by said acquirer, an electronic image in which a brightness of a partial image designated by the designating operation indicates an appropriate value, as a target of said reproducer.

2. An electronic camera according to claim 1, wherein the plurality of exposure amounts notice by said first exposer includes a reference exposure amount, and said reproducer includes an initial reproducer which initially reproduces an electronic image corresponding to the reference exposure amount.

3. An electronic camera according to claim 2, further comprising:
a second exposer which exposes said imager irrespective of the exposure operation;
an adjuster which adjusts an exposure condition based on an electronic image generated by a process of said second exposer; and
a setter which sets the reference exposure amount based on an adjustment result of said adjuster.

4. An electronic camera according to claim 1, further comprising a detector which detects a position and a size of the partial image designated by the designating operation, in association with a process of said designator, wherein said reproducer reproduces a partial image defined by the position and size detected by said detector, out of the electronic image designated by said designator.

5. An electronic camera according to claim 4, wherein said reproducer includes an enlarger which enlarges and displays the partial image defined by the position and size detected by said detector at a magnification corresponding to a display region.

6. An image processing program recorded on a non-transitory recording medium in order to control an electronic camera provided with an imager, the program causing a processor of the electronic camera to perform the steps comprises:
a first exposing step of exposing an imager in a plurality of exposure amounts different from each other when an exposure operation is accepted;
an acquiring step of acquiring a plurality of electronic images generated by a process of said first exposing step, from said imager;
a reproducing step of reproducing any one of the plurality of electronic images acquired by said acquiring step;
an accepting step of accepting a designating operation of designating a part of the electronic image reproduced by said reproducing step; and
a designating step of designating, out of the plurality of electronic images acquired by said acquiring step, an electronic image in which a brightness of a partial image designated by the designating operation indicates an appropriate value, as a target of said reproducer.

7. An image processing method executed by an electronic camera provided with an imager, comprising:
a first exposing step of exposing an imager in a plurality of exposure amounts different from each other when an exposure operation is accepted;
an acquiring step of acquiring a plurality of electronic images generated by a process of said first exposing step, from said imager;
a reproducing step of reproducing any one of the plurality of electronic images acquired by said acquiring step;
an accepting step of accepting a designating operation of designating a part of the electronic image reproduced by said reproducing step; and
a designating step of designating, out of the plurality of electronic images acquired by said acquiring step, an electronic image in which a brightness of a partial image designated by the designating operation indicates an appropriate value, as a target of said reproducer.
